(19) United States
(12) Patent Application Publication
(10) Pub. No.: US 2026/0105320 A1
(43) Pub. Date: Apr. 16, 2026

(54) DEVELOPMENT KNOWLEDGEBASE CENTRAL HUB AUTONOMOUS ASSISTANT

(71) Applicant: Bank of America Corporation, Charlotte, NC (US)

(72) Inventors: Manoj Kumar Keeppalli, Harbour Front (SG); Manu Kurian, Dallas, TX (US); Harinath Meedinti Bhaskara Reddy, Charlotte, NC (US)

(21) Appl. No.: 18/912,651

(22) Filed: Oct. 11, 2024

(51) Int. Cl. G06N 5/022

(52) U.S. Cl. CPC G06N 5/022

(57) ABSTRACT

Generative artificial intelligence (AI)-based systems and methods for increasing efficiency in a software development environment are provided. Methods may include training an AI module on a training corpus comprising historical code repositories and associated historical documentation, and receiving as input a development knowledgebase comprising a series of code repositories and associated documentation. Methods may include, in response to a first prompt, generating via the AI module a knowledgebase summary, and in response to a second prompt, generating via the AI module a documentation update. Methods may include outputting the knowledgebase summary and the documentation update, and autonomously updating the development knowledgebase by replacing the documentation in the development knowledgebase with the documentation update.

### FIELD OF TECHNOLOGY

Aspects of the disclosure relate to digital systems. Specifically, aspects of the disclosure relate to artificial intelligence (AI)-based systems for increasing efficiency in a software development environment.

### BACKGROUND OF THE DISCLOSURE

As software development has become increasingly complex and integral to nearly every industry, the demand for more efficient, accurate, and collaborative development systems and processes has intensified. Developers are tasked with managing intricate codebases, adhering to strict deadlines, and ensuring that their software is free of defects, secure, and optimized for performance.

Development teams, meanwhile, have expanded and often experience high levels of turnover. It has grown ever more challenging to maintain adequate levels of familiarity and proficiency with the development knowledgebase across new and veteran members of a development team. In general, development knowledgebases are often massive, with inevitable inefficiencies, inaccuracies, and lack of organization.

It would be desirable, therefore, to provide systems and methods for increasing efficiency and usability in a software development environment.

### SUMMARY OF THE DISCLOSURE

Aspects of the disclosure relate to generative artificial intelligence (AI)-based systems for increasing efficiency in a software development environment. The systems may include a processor, a non-transitory memory, and an AI module trained on a training corpus. The training corpus may include historical code repositories and associated historical documentation.

Systems may also include computer executable instructions stored in the memory, that, when run on the processor, are configured to receive as input a development knowledgebase comprising a series of code repositories and associated documentation.

In response to a first prompt, systems may be configured to generate via the AI module a knowledgebase summary. The knowledgebase summary may include a textual summary of the whole developmental knowledgebase.

In response to a second prompt, systems may be configured to generate via the AI module a documentation update. The documentation update may include an updated version of the documentation included in the development knowledgebase.

Systems may be configured to output the knowledgebase summary and/or the documentation update. Systems may be configured to autonomously update the development knowledgebase by replacing the documentation in the development knowledgebase with the documentation update.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative apparatus in accordance with principles of the disclosure;

FIG. 3 shows an illustrative diagram in accordance with principles of the disclosure; and

FIG. 4 shows another illustrative diagram in accordance with principles of the disclosure.

### DETAILED DESCRIPTION OF THE DISCLOSURE

Aspects of the disclosure relate to generative artificial intelligence (AI)-based systems and methods for increasing efficiency in a software development environment. System features and configurations may, in certain embodiments, correspond to steps of the methods. The systems may include a processor, a non-transitory memory, and an AI module. The AI module may be trained on a training corpus that includes historical code repositories and associated historical documentation.

Systems may also include computer executable instructions stored in the memory, that, when run on the processor, are configured to execute system features and method steps.

Systems may be configured to receive as input a development knowledgebase. The development knowledgebase may include a series of code repositories and associated documentation. The development knowledgebase may, for example, include a collection of code and documentation used by a development team, company, or platform for one or more coding projects.

In response to a first prompt, the systems may be configured to generate via the AI module a knowledgebase summary. The knowledgebase summary may include a textual summary of the whole developmental knowledgebase. The summary may conform to a predetermined format and/or length. In some embodiments, the format and/or length of the knowledgebase summary may be customizable in response to specifications included in the first prompt.

In response to a second prompt, the systems may be configured to generate via the AI module a documentation update. The documentation update may include an updated version of the documentation included in the development knowledgebase. The update may, for example, fill gaps, remove redundancies, correct inaccuracies, or generally improve the content or style of the documentation to make it more complete, succinct, accurate, or any other suitable improvement.

Systems may be configured to output the knowledgebase summary and/or the documentation update. Systems may be configured to autonomously update the development knowledgebase by replacing the documentation in the development knowledgebase with the documentation update.

In some embodiments, in response to a third prompt, the systems may be configured to generate via the AI module a code repository update. The code repository update may include an updated version of the code repository included in the development knowledgebase. Systems may be configured to output the code repository update, and/or autonomously update the development knowledgebase by replacing the code repository in the development knowledgebase with the code repository update.

In certain embodiments, updating the code repository for the code repository update may include refactoring the code in the code repository. Refactoring the code may, for example, include improving the internal structure of the code. The improvements may be designed to not change the code's external functionality. The improvements may include trimming unnecessary code lines or code steps, improving code efficiency and/or readability, augmenting the code with additional portions to improve performance, or any other suitable code improvements.

Additionally or alternatively, updating the code repository for the code repository update may include partitioning the code in the code repository into multiple functional code portions. This may include configuring each functional code portion to operate as a stand-alone software program independent of the rest of the code repository. This may, for example, include ensuring that any code segment that is applicable to more than one functional code portion is copied and incorporated into any such functional code portion (preferably, only incorporating into such functional code portions that use the code segment and not into the functional code portions which don't use the code segment).

In some embodiments, the system may be further configured to receive as input a codebase file, and generate, via the AI module, documentation for the codebase file.

In certain embodiments, the system may be further configured to receive as input a partial code segment and generate, via the AI module, an autofill recommendation to complete the partial code segment in conformance with the development knowledgebase.

In some embodiments, the system may be further configured to determine, via a connection with an external database, a current state of regulation in an industry associated with the system. The system may be further configured to toggle a functionality of the system (e.g., the function to generate the autofill recommendation or improve code versus the function to generate or improve documentation) based on conformance with the current state of regulation.

In certain embodiments, the system may be further configured to receive as input a search prompt and in response, generate a search report. The search report may include a location in the development knowledgebase associated with the search prompt, and which may serve as a response to the search prompt.

The search prompt may, in some embodiments, include a code segment. A user inputting such a search prompt may, for example, be searching for the instances in the code base that contain or are similar to the code segment. Additionally or alternatively, the search prompt may include a coding concept and/or any other prompt for which a user may desire to search the development knowledgebase. A coding concept may, for example, include a description of a function, style, characteristic, or any other feature that a user may be interested in locating in the knowledgebase (code or documentation).

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

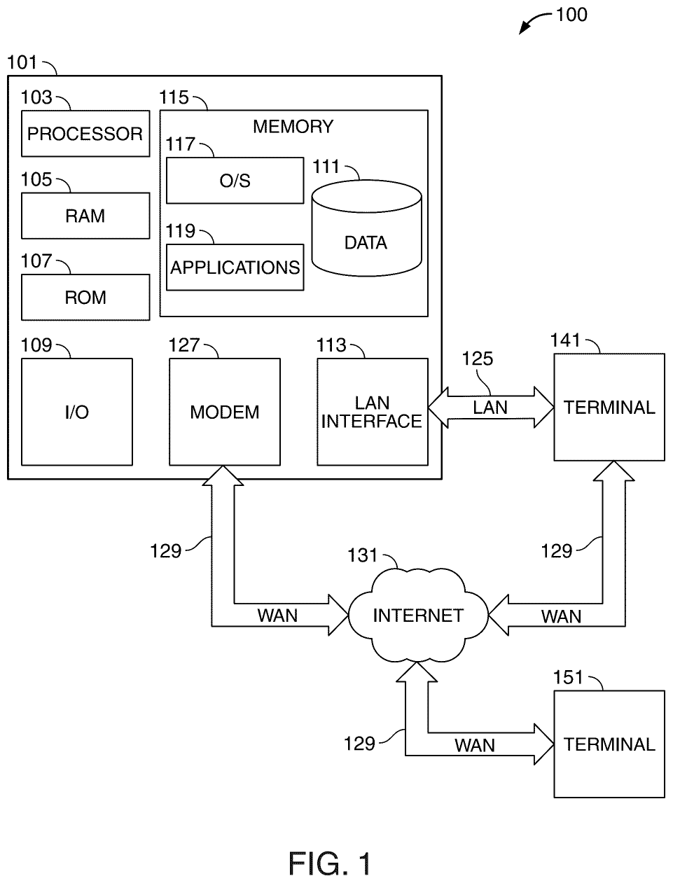

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may comprise any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to assistance in a software development environment. The input/output module may also include one or more speakers for providing audio output and a video display device for providing textual, audio, audiovisual, and/or graphical output. The input and output may be related to computer application functionality. The input and output may be related to assistance in a software development environment.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related to performing various tasks. The various tasks may be related to assistance in a software development environment.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

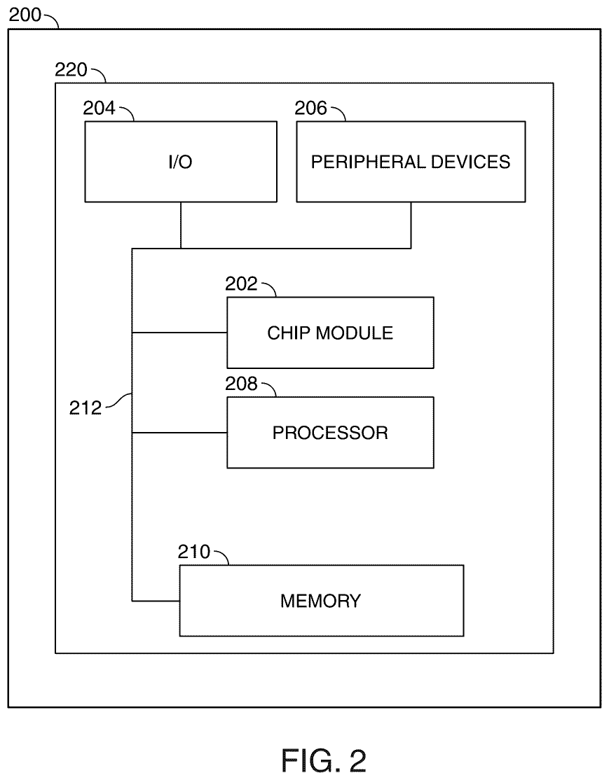

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

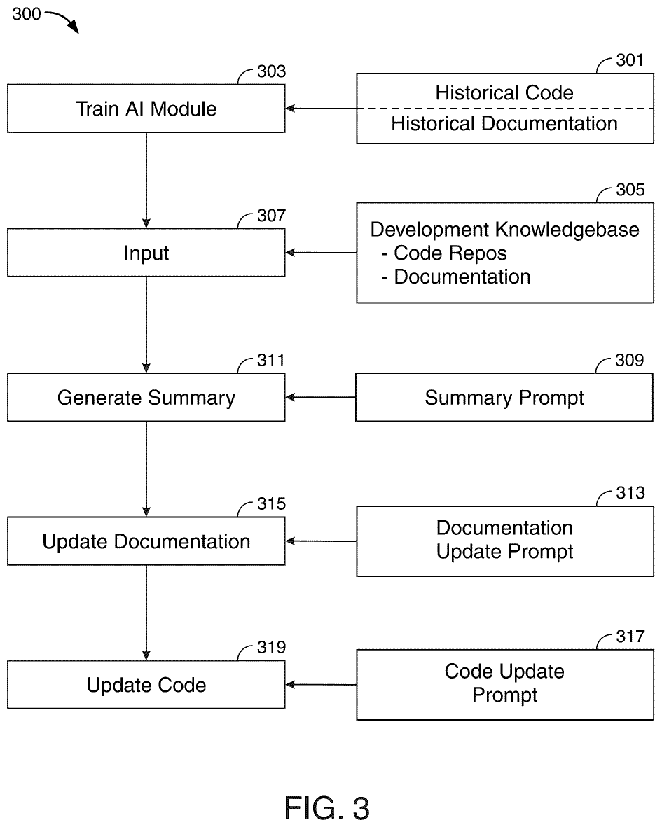

FIG. 3 shows illustrative diagram 300 in accordance with principles of the disclosure. Training corpus 301 including historical code and associated documentation may be used at step 303 to train the AI module. Development knowledgebase 305 may be fed into the system at 307 as input. First prompt 309 may include a request for a summary of development knowledgebase 305, which the system may generate at 311. Second prompt 313 may include a request for a documentation update, which the system may generate and/or implement at 315. Third prompt 317 may include a request for a code update, which the system may generate and/or implement at 319.

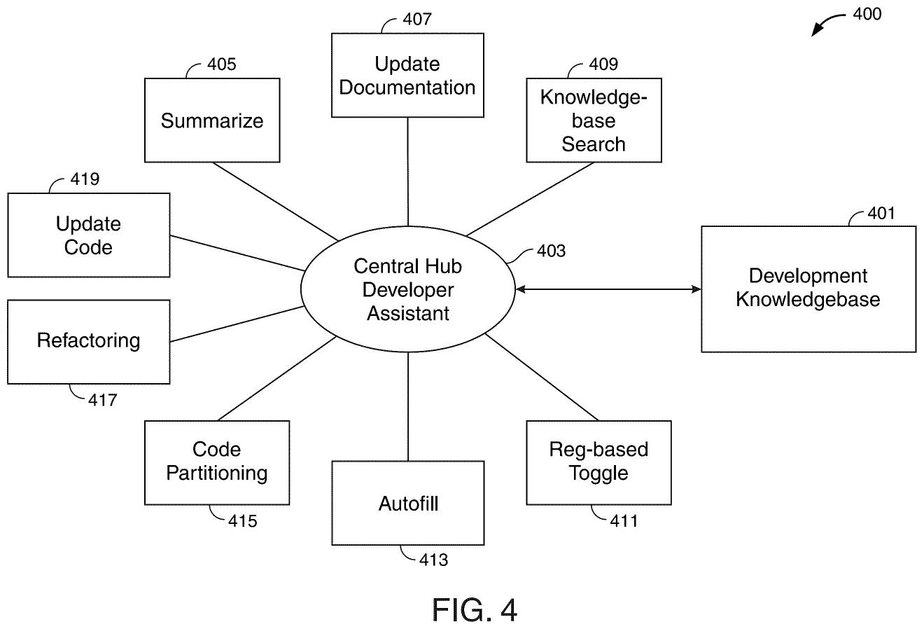

FIG. 4 shows illustrative diagram 400 in accordance with principles of the disclosure. System 403 illustrates some features and architecture of the central hub developer assistant described in this application. System 403 may be fed as input and/or be otherwise connected to development knowledgebase 401. System 403 may be configured to summarize (405) aspects of development knowledgebase 401, update documentation (407), search (409) aspects of development knowledgebase 401, provide a regulation-based feature toggle (411), provide autofill (413) for code, or improve code by partitioning (415), refactoring (417), or otherwise updating (419).

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for a development knowledgebase central hub autonomous assistant are provided. Persons skilled in the art will appreciate that the present invention can be practiced by other than the described embodiments, which are presented for purposes of illustration rather than of limitation, and that the present invention is limited only by the claims that follow.

What is claimed is:

1. A generative artificial intelligence (AI)-based system for increasing efficiency in a software development environment, the system comprising:
a processor;
an AI module trained on a training corpus comprising historical code repositories and associated historical documentation;
a non-transitory memory; and
computer executable instructions stored in the memory, that, when run on the processor, are configured to:
receive as input a development knowledgebase comprising a series of code repositories and associated documentation;
in response to a first prompt, generate via the AI module a knowledgebase summary, said knowledgebase summary comprising a textual summary of the whole developmental knowledgebase;
in response to a second prompt, generate via the AI module a documentation update, said documentation update comprising an updated version of the documentation included in the development knowledgebase;
output the knowledgebase summary and the documentation update; and
autonomously update the development knowledgebase by replacing the documentation in the development knowledgebase with the documentation update.

2. The system of claim 1 further configured to:
in response to a third prompt, generate via the AI module a code repository update, said code repository update comprising an updated version of the code repository included in the development knowledgebase;
output the code repository update; and
autonomously update the development knowledgebase by replacing the code repository in the development knowledgebase with the code repository update.

3. The system of claim 2 wherein updating the code repository for the code repository update comprises refactoring the code in the code repository.

4. The system of claim 2 wherein updating the code repository for the code repository update comprises:
partitioning the code in the code repository into a plurality of functional code portions; and
configuring each functional code portion to operate as an stand-alone software program independent of the rest of the code repository.

5. The system of claim 1 further configured to:
receive as input a codebase file; and
generate, via the AI module, documentation for the codebase file.

6. The system of claim 1 further configured to:
receive as input a partial code segment; and
generate, via the AI module, an autofill recommendation to complete the partial code segment in conformance with the development knowledgebase.

7. The system of claim 6 further configured to:
determine, via a connection with an external database, a current state of regulation in an industry associated with the system; and
toggle a functionality of the system to generate the autofill recommendation based on conformance with the current state of regulation.

8. The system of claim 1 further configured to:
receive as input a search prompt; and
generate a search report comprising a location in the development knowledgebase associated with the search prompt.

9. The system of claim 8 wherein the search prompt comprises a code segment.

10. The system of claim 8 wherein the search prompt comprises a coding concept.

11. A generative artificial intelligence (AI)-based method for increasing efficiency in a software development environment, the method comprising:
training an AI module on a training corpus comprising historical code repositories and associated historical documentation
receiving as input a development knowledgebase comprising a series of code repositories and associated documentation;
in response to a first prompt, generating via the AI module a knowledgebase summary, said knowledgebase summary comprising a textual summary of the whole developmental knowledgebase;
in response to a second prompt, generating via the AI module a documentation update, said documentation update comprising an updated version of the documentation included in the development knowledgebase;
outputting the knowledgebase summary and the documentation update; and
autonomously updating the development knowledgebase by replacing the documentation in the development knowledgebase with the documentation update.

12. The method of claim 11 further configured to:
in response to a third prompt, generate via the AI module a code repository update, said code repository update comprising an updated version of the code repository included in the development knowledgebase;
output the code repository update; and
autonomously update the development knowledgebase by replacing the code repository in the development knowledgebase with the code repository update.

13. The method of claim 12 wherein updating the code repository for the code repository update comprises refactoring the code in the code repository.

14. The method of claim 12 wherein updating the code repository for the code repository update comprises:
partitioning the code in the code repository into a plurality of functional code portions; and
configuring each functional code portion to operate as an stand-alone software program independent of the rest of the code repository.

15. The method of claim 11 further comprising:
receiving as input a codebase file; and
generating, via the AI module, documentation for the codebase file.

16. The method of claim 11 further comprising:
receiving as input a partial code segment; and
generating, via the AI module, an autofill recommendation to complete the partial code segment in conformance with the development knowledgebase.

17. The method of claim 16 further comprising:
determining, via a connection with an external database, a current state of regulation in an industry associated with the system; and
toggling a functionality of the system to generate the autofill recommendation based on conformance with the current state of regulation.

18. The method of claim 11 further comprising:
receiving as input a search prompt; and
generating a search report comprising a location in the development knowledgebase associated with the search prompt.

19. The method of claim 18 wherein the search prompt comprises a code segment.

20. The method of claim 18 wherein the search prompt comprises a coding concept.
